(19) United States
(12) Patent Application Publication
(10) Pub. No.: US 2004/0143623 A1
(43) Pub. Date: Jul. 22, 2004

(54) Network service mediation method, network service mediation device and network service mediation program

(75) Inventors: Masayuki Fukui, Kawasaki (JP); Yasuhide Matsumoto, Kawasaki (JP); Hidenobu Ito, Kawasaki (JP); Kazuo Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/739,025

(22) Filed: Dec. 19, 2003

(30) Foreign Application Priority Data
Jan. 21, 2003 (JP) 2003-012821

(51) Int. Cl. G06F 15/16

(52) U.S. Cl. 709/200

(57) ABSTRACT

A mediation device includes a search portion, a mediation portion, a sending portion and a management database. The search portion searches in the management database the web services to which search conditions entered by a client apply. The mediation portion receives a selection of web services extracted based on the search conditions, and requests execution of the selected web services from web service servers. The management database stores search results and selection results of the web services. The sending portion sends result data including the search results and selection results of the web services to the web service servers. Thus, the value of providing the web services can be increased by allowing the monitoring of user behavior.

### FIELD OF THE INVENTION

The present invention relates to network services provided over a network.

### BACKGROUND ART

With conventional websites, people access information that is stored on that websites through browser software or the like. And with conventional web applications, input, update and access of data is performed in accordance with requests from the launched web application. That is to say, conventional web sites and web applications are designed to facilitate interaction between people and computers, and they are based on the premise that the services provided on a network are accessed by people.

On the other hand, under the moniker of “web services,” a technology is beginning to be presented that makes it possible to utilize services that are offered on a network and linked to one another, without going through people. With web services, a service offered on a network is registered with the interface when utilizing that service. The user selects at least one service that is necessary to satisfy certain requirements. When a service is selected, that service is executed in accordance with an interface that is stored in correspondence with the selected service, and an execution result satisfying the requirements is obtained. That is to say, in web services, the services provided on the network are treated as if they were individual components, and the services of these components can be executed in any combination.

Moreover, by making use of the interconnectivity of web services, it is possible to offer users portal sites that merge a group of web services offered by a plurality of providers that are in competition with one another, and to build a web service mediation system that mediates between users and web services. Such a web service mediation system provides functionality with which a user can select and use a specific web service from a group of web services that are in competition with one another.

On the other hand, in systems based on conventional website technology, electronic commerce systems have become widespread, in which products and services are offered directly to the user over a network. Among such electronic commerce systems, there are systems that collect information related to the access patterns of users accessing the electronic commerce system, and analyze the behavior of users that have accessed the system from this information (see for example JP 2002-56169A). Using such an electronic commerce system, based on the analyzed user behavior, it is possible to reevaluate the items in stock, revise prices, or offer new products or services, and it is possible to increase the usage value of the electronic commerce system.

In the future, products and services that are offered by electronic commerce systems based on web service technology will not be offered by just one network service, but by a plurality of network services. To the user, it will look as if accessing a conventional website, but in actuality, services and products are offered by linking the web services of manufacturers and retailers offering those products in the background of the accessed website. In this case, it is conceivable that the services and products offered to the user are aggregated on one site, but different from the conventional website paradigm in which the requested services and products are offered in accordance with the content accessed by the user, the network service accessed by the user functions only as a user portal that merely brokers network services offering actual services and products. This way, the user does not directly access the network services offering the actual services or products, and it becomes difficult for the network services offering the actual services or products to directly observe and monitor the user's access behavior.

However, also in web service technology allowing to freely select and use any of a group of competing network services, there is a need for increasing the value of the web service as well as increasing its competitive power by monitoring user behavior and reflecting it in the offered services.

It is thus an object of the present invention to increase the value of network services by making it possible to monitor user behavior.

### SUMMARY OF THE INVENTION

According to a first aspect of the present invention, a network service mediation method for mediating execution of one or a plurality of network services that are provided over a network includes:

a storage step of storing network service information related to the network services;

a search condition entry step of receiving an entry of a search condition for searching the network services;

an extraction step of extracting the network service information for which the search condition is true;

a selection step of receiving a selection of one or a plurality of network services from the network services corresponding to the extracted network service information;

a requesting step of requesting execution of the selected one or plurality of network services; and

a sending step of sending selection information related to the selection of the network services.

With this configuration, selection information related to the selection of network services, such as web services, is sent out. Consequently, it is possible to monitor user behavior, such as which network service the user has selected, based on the sent selection information. Moreover, it is possible to improve the content provided by the network service based on the user behavior, so that the value of the network service can be improved.

According to a second aspect of the present invention, the network service information comprises network service specific information for which the network service can be specified. With this configuration, the network services can be specified based on the network service specific information included in the network service information.

According to a third aspect of the present invention, a portion or all of the network service information related to the selected one or plurality of network services is sent to some or all of the network service servers that execute the network services specified by the network service specific information comprised in extracted the network service information. With this configuration, the network service information related to the selected network services is sent to the network service servers. Consequently, the user behavior can be monitored with the network service servers, and the value of the network service can be increased.

According to a fourth aspect of the present invention, the selection information comprises the search condition. With this configuration, based on the search condition included in the selection information, it is possible to monitor what kind of network service the user is trying to use.

According to a fifth aspect of the present invention, the network service mediation method further includes a user information storage step of storing user information related to users who can enter search conditions, and that the selection information comprises some or all of the user information of the users who have specified search conditions. With this configuration, information related to a user who has specified a search condition is included in the selection information and sent out. Consequently, based on this information related to the user, it is possible to perform a detailed analysis of the preferred network service of each user, trends in selecting network services, as well as tendencies for users of a certain gender or age group to select a specified network service, thus making it possible to increase the value of the network service.

According to a sixth aspect of the present invention, the network service mediation method further includes a permission step of receiving a permission to send network service information, and that the sending step is executed if that permission has been received. With this configuration, selection information is sent out only if this has been permitted. Consequently, it can be prevented that selection information of a given network service is sent to the providers of other network services, and that valuable information is leaked to providers of competing network services.

According to a seventh aspect of the present invention, the storage step comprises an obtaining step of accessing, at a predetermined timing, a database storing in correlation to one another the network services and the network service information which is related to content of the network services, and obtaining and storing the network service information. With this configuration, network service information is obtained and stored at a predetermined timing from the database. The database may be, for example, a UDDI (Universal Description, Discovery and Integration) directory.

According to an eighth aspect of the present invention, the selection information comprises the network service information extracted in the extraction step. With this configuration, network service information corresponding to network services to which the entered search condition applies is included in the selection information and sent out. Based on this network service information, the providers of the network services can be alerted to network services that have not been selected although they have been searched. Consequently, it is possible to compare selected network services and not selected network services, which is useful for improving the network services.

In accordance with a ninth aspect of the present invention, a network service mediation method for mediating execution of one or a plurality of network services that are provided over a network includes:

a search condition entry step of receiving an entry of a search condition for searching the network services;

an extraction requesting step of requesting, from a database in which the network services and network service information related to content of the network services are stored in correlation to one another, extraction of a network service or network services corresponding to network service information for which the search condition is true;

a selection step of receiving a selection of one or a plurality of network services from the extracted network services;

an execution requesting step of requesting execution of the selected one or plurality of network services; and

a sending step of sending service extraction selection information related to the extraction or selection of the network services to at least one of the extracted network services.

With this configuration, the extraction of network services corresponding to network service information to which the specified search condition applies is requested from a database. Here, the database may be for example a UDDI directory. The selection of the network service is received from the extracted network services. Execution of the selected network services is requested. The request for execution is carried out by sending a SOAP (Simple Object Access Protocol) message, for example. Then, service extraction selection information related to the extraction or selection of network services is sent to at least one of the extracted network services.

Thus, since service extraction selection information is sent to at least one of the extracted network services, the providers of the network services can monitor, based on the service information, such behavior as which network service has been extracted or which network service has been selected. Then, based on this behavior information, they can improve the content provided by the network services, increasing the value of the network services.

In accordance with a tenth aspect of the present invention, a network service mediation device for mediating execution of one or a plurality of network services that are provided over a network includes:

a storage means for storing network service information related to the network services;

a search condition entry means for receiving an entry of a search condition for searching the network services;

an extraction means for extracting the network service information for which the search condition is true;

a selection means for receiving a selection of one or a plurality of network services from the network services corresponding to the extracted network service information;

a requesting means for requesting execution of the selected one or plurality of network services; and

a sending means for sending selection information related to the selection of the network services.

In accordance with an eleventh aspect of the present invention, a network service mediation device for mediating execution of one or a plurality of network services that are provided over a network includes:

a search condition entry means for receiving an entry of a search condition for searching the network services;

an extraction requesting means for requesting, from a database in which the network services and network service information related to content of the network services are stored in correlation to one another, extraction of a network service or network services corresponding to network service information for which the search condition is true;

a selection means for receiving a selection of one or a plurality of network services from the extracted network services;

an execution requesting means for requesting execution of the selected one or plurality of network services; and

a sending means for sending service extraction selection information related to the extraction or selection of the network services to at least one of the extracted network services.

In accordance with a twelfth aspect of the present invention, a network service mediation program for mediating execution of one or a plurality of network services that are provided over a network lets a computer function as:

a storage means for storing network service information related to the network services;

a search condition entry means for receiving an entry of a search condition for searching the network services;

an extraction means for extracting the network service information for which the search condition is true;

a selection means for receiving a selection of one or a plurality of network services from the network services corresponding to the extracted network service information;

a requesting means for requesting execution of the selected one or plurality of network services; and

a sending means for sending selection information related to the selection of the network services.

In accordance with a thirteenth aspect of the present invention, a computer-readable recording medium stores a network service mediation program for mediating execution of one or a plurality of network services that are provided over a network, the program letting a computer function as:

a storage means for storing network service information related to the network services;

a search condition entry means for receiving an entry of a search condition for searching the network services;

an extraction means for extracting the network service information for which the search condition is true;

a selection means for receiving a selection of one or a plurality of network services from the network services corresponding to the extracted network service information;

a requesting means for requesting execution of the selected one or plurality of network services; and

a sending means for sending selection information related to the selection of the network services.

### BRIEF DESCRIPTION OF THE DRAWINGS

FIG. 1 is a diagram showing the overall configuration of a web service mediation system according to a first embodiment.

FIG. 2 is a schematic diagram of the data stored in the management table.

FIG. 3 is a schematic diagram of the data stored in the search result table.

FIG. 4 is a schematic diagram of the data stored in the user profile table.

FIG. 5A is an example of a search result record included in the result data.

FIG. 5B is an example of an extracted user profile record included in the result data.

FIG. 5C is an example of selection result specific information included in the result data.

FIG. 6 is a flowchart of the search condition sending process.

FIG. 7 is a flowchart of the web service selection data sending process.

FIG. 8 is a flowchart of the search process.

FIG. 9 is a flowchart of the web service execution mediation process.

FIG. 10 is flowchart of the result data sending process.

FIG. 11 shows an example of the search screen.

FIG. 12 shows an example of the selection screen.

FIG. 13 shows an example of the web service execution result screen.

FIG. 14 shows an example of search condition data.

FIG. 15 shows an example of web service selection data.

FIG. 16 shows an example of a web service execution request.

FIG. 17 shows an example of a search result record.

FIG. 18 is a diagram showing the overall configuration of a web service mediation system according to a second embodiment.

FIG. 19 is a schematic diagram of data stored in the customer table.

### PREFERRED EMBODIMENTS OF THE INVENTION

First Embodiment

(1) Configuration

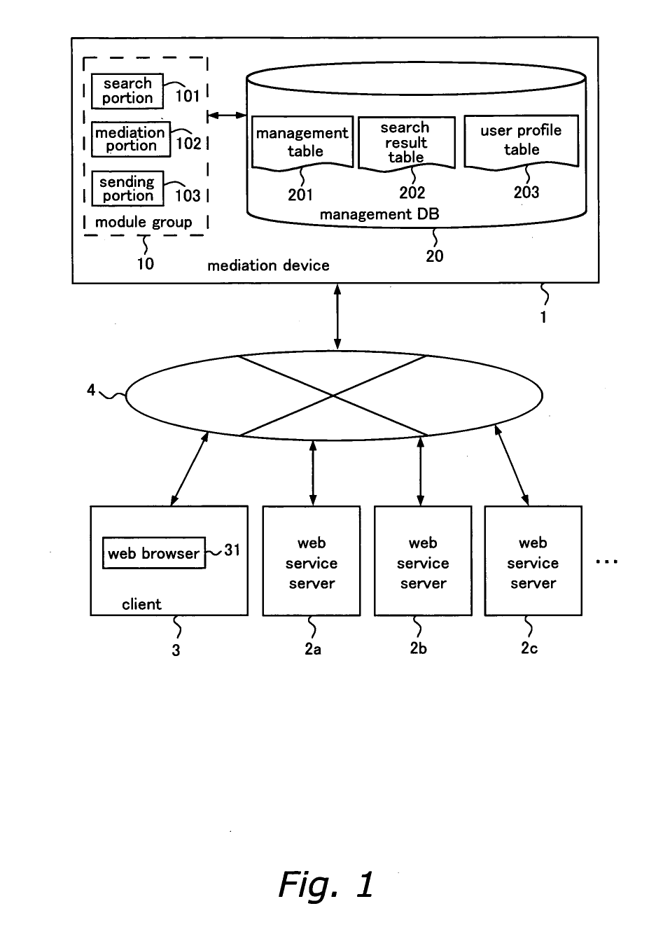

FIG. 1 is a diagram showing the overall configuration of a web service mediation system according to a first embodiment. In this system, a mediation device 1, web service servers 2a, 2b, 2c . . . , and a client 3 are connected over a network 4. The client 3 is provided with a web browser 31 as known in the art.

The web service server 2a is a server providing web services. In this embodiment, “web services” refers to services that use technology related to the world wide web (www), and with which software functionality can be used through a network. In other words, the functions of software components are available on a network, and are designed such that by freely combining a plurality of available software components, it is possible to build an application. As a description language describing the procedure for describing and calling the functions of the software components, that is, the content of the services provided by the functions of the individual software components that are registered as web services as well as the procedure when utilizing these software functions, WSDL (web service description language) and others have been considered. By using these service description languages and registering the functions of the software components in a directory database such as a UDDI (Universal Description, Discovery and Integration) directory, it becomes possible to search and utilize the functions of the software components available on the network, and it becomes possible to utilize the functions of the software components in accordance with the registered utilization procedure. As a communication protocol when utilizing the functions of the software components, SOAP (Simple Object Access Protocol) or the like has been considered. It should be noted that this embodiment is explained on the premise of state of the art web services, but it is sufficient if it is designed such that the functions of software components are available on the above-described network, and a plurality of available software components can be freely combined to build applications, and the specific implementation of the web service is not limited to state of the art services.

In the present embodiment, a request for execution of the web service is sent from the client 3 via the mediation device 1 to the web service server 2a. In the following, if not indicated otherwise, the web service servers 2b, 2c . . . are assumed to have the same configuration and functionality as the web service server 2a, and all are collectively referred to as web service servers 2.

The mediation device 1 includes a module group 10 and management database (DB) 20. The management DB 20 includes a management table 201, a search result table 202, and a user profile table 203.

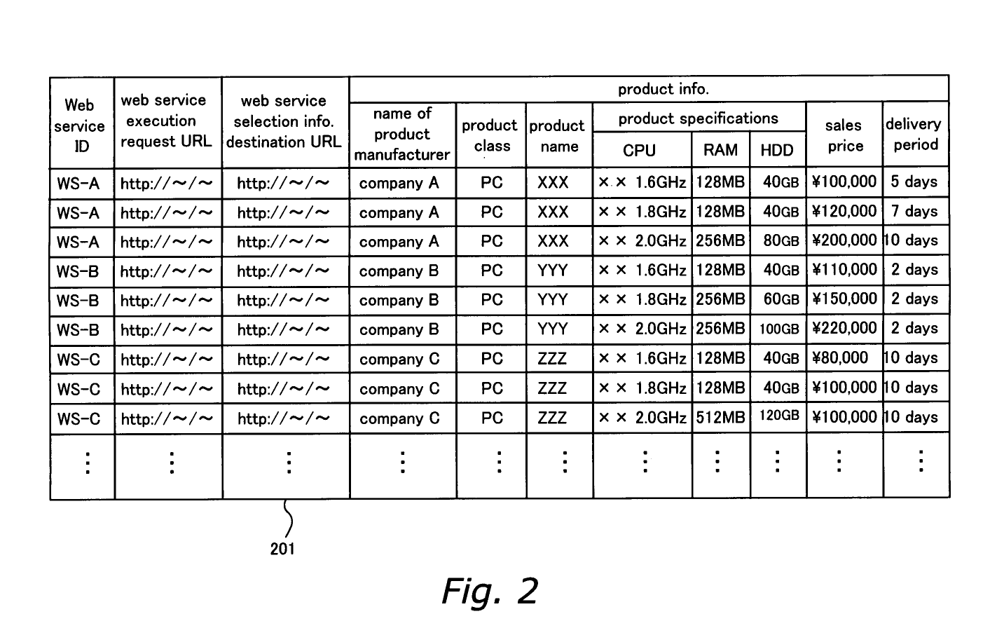

FIG. 2 is a schematic diagram of the data stored in the management table 201. This table stores the data needed by the mediation device 1 to manage the web service server 2. This table contains for example the fields “web service ID,” “web service execution request URL,” “web service selection information destination URL,” and “product information.” The field “product information” contains the sub-fields “name of product manufacturer,” “product class,” “product name,” “product specifications,” “sales price,” and “delivery period.” The sub-field “product specifications” further include the sub-fields “CPU,” “RAM,” and “HDD.” In the following, the data stored in the management table 201 is referred to as “management information.” Moreover, the data stored in the field “product information” is referred to as “product information.”

The field “web service ID” stores an identifier of the web-service servers 2, such as “WS-A.” In the present embodiment, the web service IDs WS-A, WS-B and WS-C are the identifiers of the web service server 2a, the web service server 2b, and the web service server 2c, respectively. The field “web service execution request URL” stores the URL to which the web service execution request is sent. The field “web service selection information destination URL” stores the URL to which the web service selection data (described below) is sent in the web service selection data sending process (described below). In the field “product information,” information related to products for which the web service servers 2 take orders, as an example of a web service execution request, is stored. Here, detailed information related to the products is stored in the fields “name of product manufacturer,” “product class,” “product name,” “product specifications,” “sales price,” and “delivery period.”

It should be noted that the management table 201 also may be provided outside the mediation device 1. For example, a directory, such as a UDDI directory in which the service content and usage procedure of the above-described web services are registered, may be provided outside the mediation device 1, and it may be devised to be directly searchable as the management table 201. Alternatively, it is possible to devise the system such that a directory, such as a UDDI directory provided outside the mediation device 1 every day at e.g. 0 am, is searched at predetermined intervals, information regarding the content of the web service provided by the web service servers 2 is obtained, and stored in the management table 201.

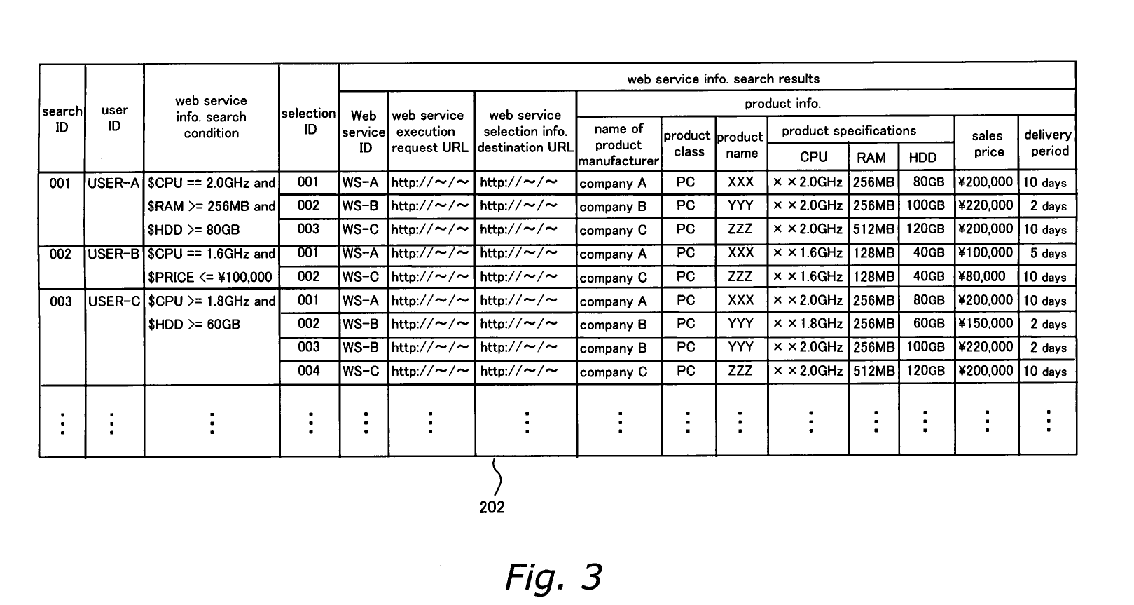

FIG. 3 is a schematic diagram of the data stored in the search result table 202. This table stores the search conditions that a user of the client 3 has entered in a later-described search screen (see FIG. 11) in order to search the web services that the user wants to use. This table contains, for example, the fields “search ID,” “user ID,” “web service information search conditions,” “selection ID,” and “web service information search results.” “Search ID” is an identifier attached to the search conditions that are entered by the user of the client 3 in the search process described below. The field “user ID” stores an identifier of the user who has entered the search conditions. The field “web service information search conditions” stores the search conditions of the web services as entered by the user. The field “web service information search results” stores records of the management table 201 that match the search conditions entered by the user. These records are extracted from the management table 201 in accordance with the search conditions by a search process that will be described later. The field “selection ID” stores identifiers of these extracted record. In the following, the data stored in the search result table 202 is referred to as “search result information.”

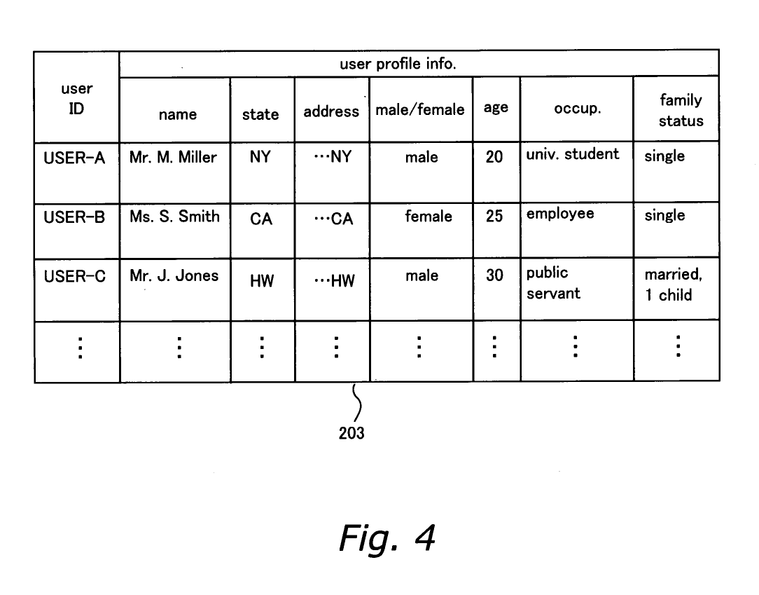

FIG. 4 is a schematic diagram of the data stored in the user profile table 203. This table stores the information related to the user of the client 3. This table contains, for example, the fields “user ID” and “user profile information.” The field “user ID” stores an identifier of the user of the client 3. The field “user profile information” stores detailed information related to the user. Here, the field “user profile information” contains, for example, the sub-fields “name,” “state,” “address,” “male/female,” “age,” “occupation” and “family status.” The sub-fields “name,” “state,” “address,” “male/female,” “age,” “occupation” and “family status” respectively store the user's name, state of residence, address, gender, age, occupation and family status. It should be noted that the user profile table 203 may also be provided outside the mediation device 1.

The module group 10 includes a search portion 101, a mediation portion 102 and a sending portion 103. The search portion 101 receives the search conditions specified on the search screen (explained below), and extracts records matching these search conditions from the management table 201. The mediation portion 102 sends the web service execution request that has been sent from the web browser 31 of the client 3 to the web service server 2 specified in this web service execution request. The sending portion 103 sends the result data to the web service servers 2, in a result data sending process which will be explained below. The processes performed by the search portion 101, the mediation portion 102 and the sending portion 103 will be explained below.

(2) Screen Examples

The following is an example of screen examples illustrating the present embodiment.

FIG. 11 shows an example of the search screen. In this screen, the user of the client 3 can enter the conditions for searching the desired web services. In the following, the conditions entered in this screen are referred to as “search conditions.” In this screen, the search conditions can be entered by selecting, for example, “CPU type,” “RAM capacity,” and HDD capacity” from drop-down lists. When clicking the “search” button, the web browser 31 sends the entered search conditions to the search portion 101.

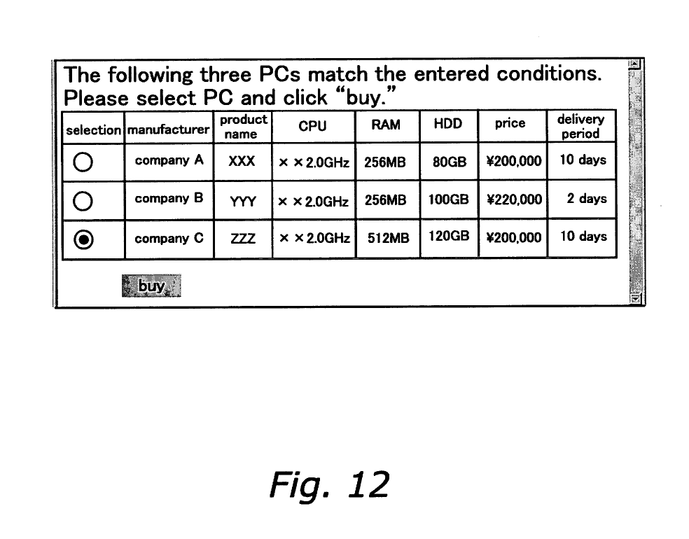

FIG. 12 is an example of the selection screen. In this screen, a list of the web services matching the search conditions that were entered in the search screen is displayed. With this screen, the desired web service can be selected by clicking the radio buttons in the “selection” column on the left in the screen. One or more web services can be selected with the radio buttons, and when the “buy” button is clicked, the web browser 31 requests from the mediation portion 102 the execution of the selected web service.

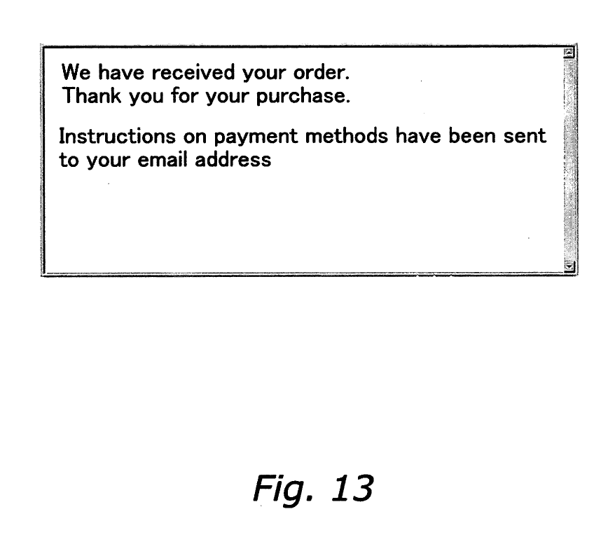

FIG. 13 shows an example of a web service execution result screen. This screen shows the result of executing the web service with the web service server 2. Through a web service execution request process explained below, this screen is sent to the client 3 that has requested the execution of the web service.

(3) Flow of the Processing Performed by the Web Service Mediation System

The following is an explanation of the processing performed by the system.

(3-1) Processing Performed by the Client

First, the flow of the processing performed by the client 3 is explained. The client 3 performs a search condition sending process and a web service selection data sending process. The following is an explanation of these processes.

(3-1-1) Search Condition Sending Process

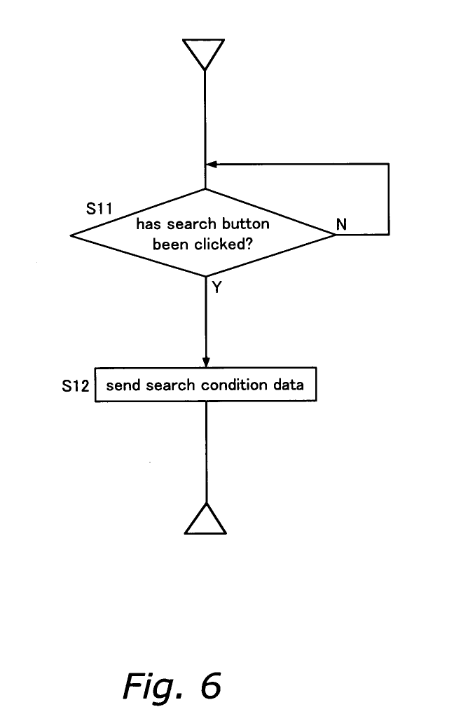

First the flow of the search process is explained based on the flowchart in FIG. 6. In this process, search condition data representing the search conditions entered in the search screen are sent to the mediation device 1. This process starts when the search screen is actively displayed by the client 3, and ends when the search screen is closed.

Step S11: The web browser 31 determines whether the “search” button in the search screen has been clicked. If it has been clicked, then the procedure advances to Step S12. If it has not been clicked, then the same determination is repeated until the “search” button is clicked.

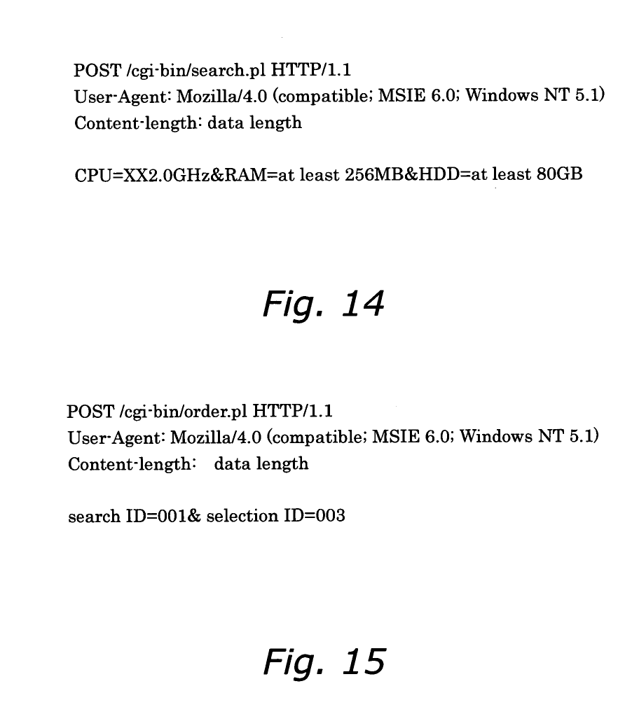

Step S12: The web browser 31 sends the search condition data representing the search conditions entered in the search screen to the mediation device 1. As shown for example in FIG. 14, the search condition data can be sent by the POST method of HTTP (Hypertext Transfer Protocol). The search condition data may also be text data. The search condition data shown as an example in FIG. 14 includes the information “CPU=XX2.0GHz&RAM=at least 256MB&HDD=at least 80GB,” with which the product information can be extracted from the management table 201.

With this process, the search condition data representing the search conditions entered in the search screen is sent from the client 3 to the mediation device 1.

(3-1-2) Web Service Selection Data Sending Process

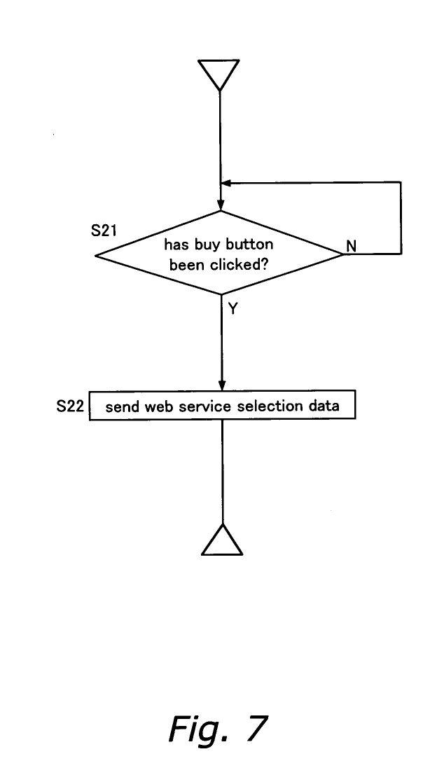

The following is an explanation of the flow of the web service selection data sending process, based on the flowchart in FIG. 7. In this process, selection data indicating the web service that has been selected in the selection screen is sent to the mediation device 1. This process starts when the selection screen is actively displayed by the client 3, and ends when the selection screen is closed.

Step S21: After a web service has been selected with the radio buttons in the selection screen, the web browser 31 determines whether the “buy” button has been clicked. If it has been clicked, then the procedure advances to Step S22. If it has not been clicked, then the same determination is repeated until the “buy” button is clicked.

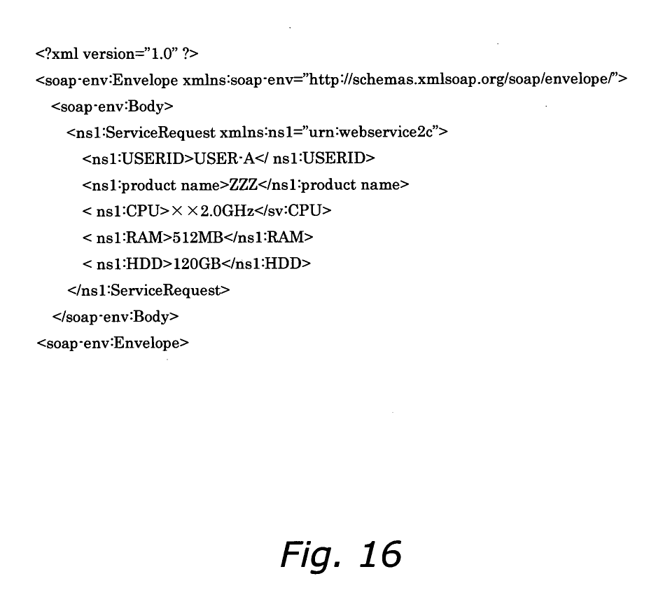

Step S22: The web browser 31 sends web service selection data that includes information specifying in the search result table 202 the web service that has been selected in the selection screen (referred to as “selection result specific information” in the following) to the mediation device 1. The web service selection data can be sent by the POST method of HTTP, as shown for example in FIG. 15. The selection result specific information is, for example, “search ID=001&selection ID=003” in the web service selection data shown in FIG. 15.

With the above process, the web service selection data including the selection result specific information is sent to the mediation device 1.

(3-2) Processing Performed by the Mediation Device

The following is an explanation of the flow performed by the mediation device 1. The mediation device 1 carries out a search process, a web service execution mediation process, and a result data sending process. The following is an explanation of these processes.

(3-2-1) Search Process

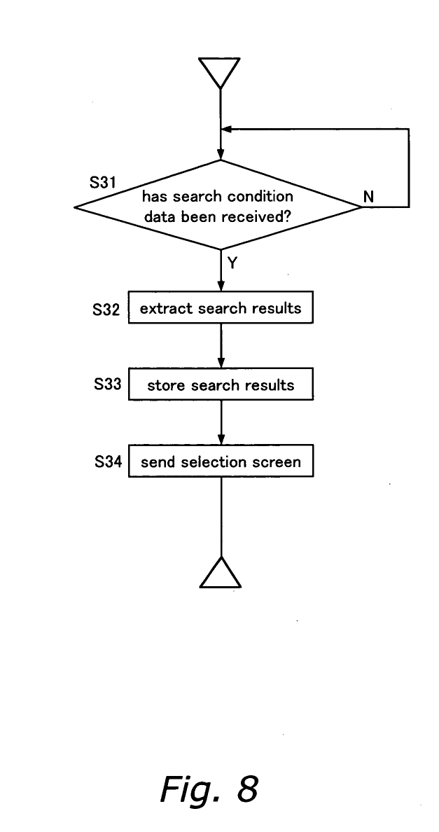

First, the flow of the search process is explained based on the flowchart shown in FIG. 8. This process extracts records including web service information matching the search conditions entered by the user from the management table 201. Then, a selection screen (see FIG. 12) displaying the extracted records as a list of web services matching the search conditions is sent to the web browser 31. This process starts when the mediation device 1 is started up, and ends when the mediation device 1 is shut down.

Step S31: The search portion 101 determines whether search condition data has been received. If search condition data has been received, the procedure advances to Step S32, and if search condition data has not been received, the determination is repeated until search condition data is received.

Step S32: The search portion 101 searches the management table 201 with the search conditions included in the search condition data as the key, and extracts the records for which those search conditions are true. In the following, the records extracted in this step are referred to as “extracted records.”

Step S33: The search portion 101 attaches a unique selection ID to each of the extracted records, and furthermore attaches a unique search ID corresponding to the search condition data received in Step S31. In the following, the extracted records to which a selection ID and a search ID has been attached are referred to as “search result records.” Then, the search result records are stored in the search result table 202. In the present embodiment, the search result records include the web service IDs “WS-A,” “WS-B” and “WS-C” for the web service 2a, web service 2b and web service 2c, as shown as an example in FIG. 17.

Step S34: The search portion 101 generates a selection screen based on the search result records, and sends it to the web browser 31. The selection screen can be generated as shown for example in FIG. 12, if the search result records are as shown in FIG. 17, for example. For example, the information stored in the fields “name of product manufacturer,” “product name,” “CPU,” “RAM,” “HDD,” “sales price” and “delivery period” of the search result records can be extracted and the HTML (Hypertext Markup Language) data for the selection screen can be generated from this information.

(3-2-2) Web Service Execution Mediation Process

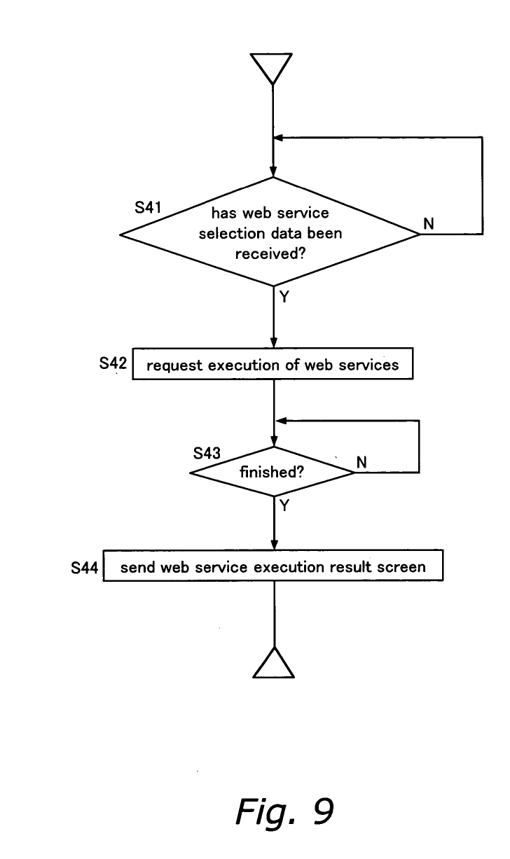

Next, the flow of the web service execution mediation process is explained based on the flowchart shown in FIG. 9. This process mediates the execution of the selected web service, which is the web service that has been selected in the selection screen. This process starts when the mediation device 1 is started up, and ends when the mediation device 1 is shut down.

Step S41: The mediation portion 102 determines whether web service selection data has been received. If web service selection data has been received, the procedure advances to Step S42, and if web service selection data has not been received, the determination is repeated until web service selection data is received.

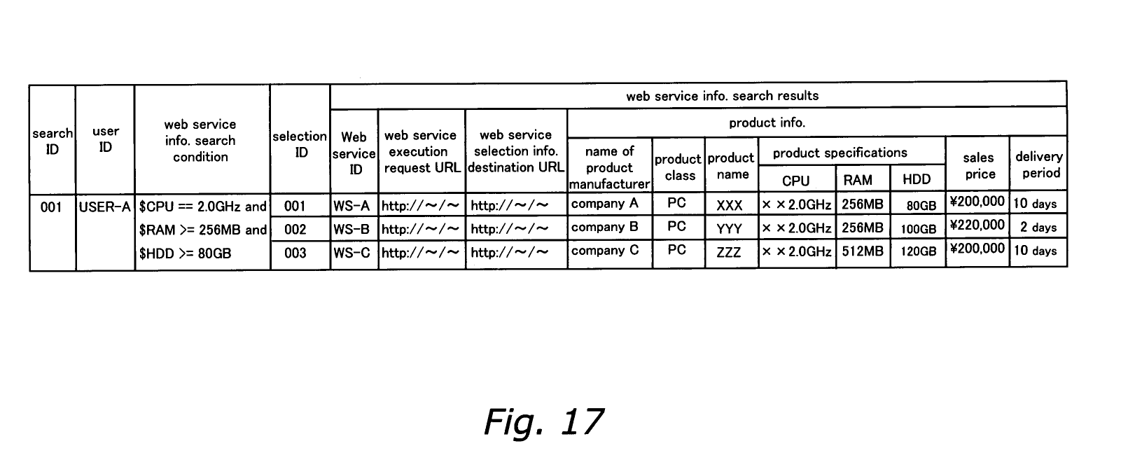

Step S42: The mediation portion 102 sends a web service execution request for requesting execution of web services to the web service server 2 that is specified by the selection result specific information included in the web service selection data, that is, the web service server 2c in the current example. This web service execution request includes the information required by the web service server 2 to execute the web service. Let us assume, for example, that the radio button at the bottom-most row in the selection screen in FIG. 12 has been selected. In this case, the web service execution request may be a SOAP envelope containing the information ‘user ID=“001” product name=“ZZZ” CPU=“XX2.0GHz” RAM=“512MB” HDD=“120GB”’ which represents the name and the specifications of the ordered product, as shown in FIG. 16.

Step S43: The mediation portion 102 determines whether the web service server 2 that has received the web service execution request has terminated the execution of web services. If terminated, the procedure advances to Step S44. If not terminated, this determination is repeated until terminated. It should be noted that the determination whether the execution of the web services has been terminated can be performed by whether a message indicating the termination of the execution of the web service has been received from the web service server 2, for example.

Step S44: The mediation portion 102 sends a web service execution result screen as shown for example in FIG. 13 to the web browser 31.

With the above processing, the client 3 can request the execution of web services through the mediation device 1 from the web service servers 2, and receive the execution result of the web services.

(3-2-3) Result Sending Process

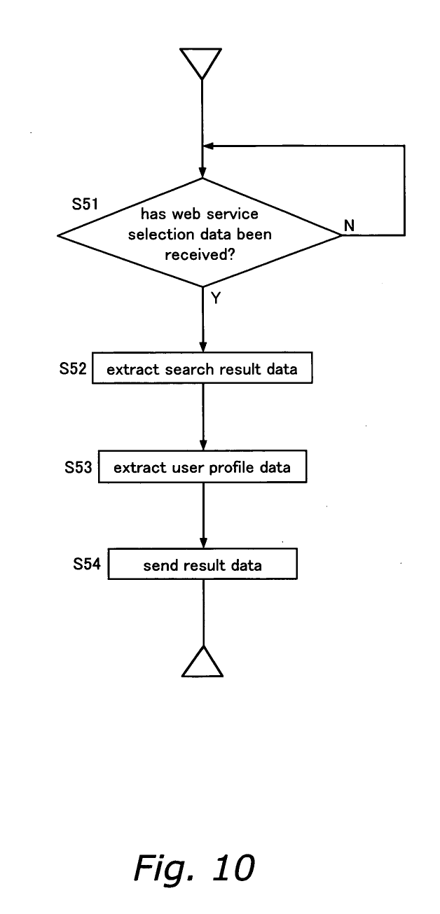

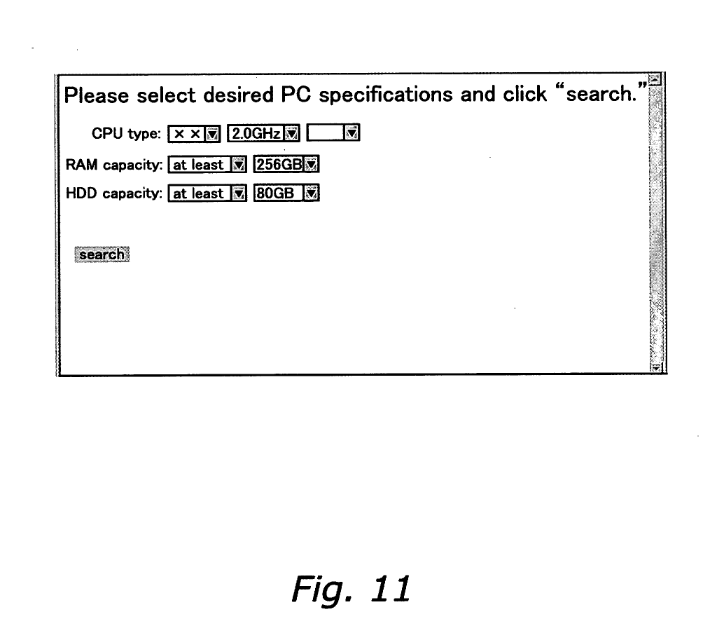

The following is an explanation of the flow of the result sending process, based on the flowchart shown in FIG. 10. This process sends the search result and the selection result to the web service server 2 specified by the web service ID included in the search result record. This process starts when the mediation device 1 is started up, and ends when the mediation device 1 is shut down.

Step S51: The sending portion 103 determines whether the mediation portion 102 has received the web service selection data. If the mediation portion 102 has received the web service selection data, the procedure advances to Step S52, and if not, then the determination is repeated until the mediation portion 102 has received the web service selection data.

Step S52: The sending portion 103 extracts the search result records from the search result table 202, based on the web service selection data received by the mediation portion 102.

Step S53: The sending portion 103 extracts the record including the user IDs included in the search result records from the user profile table 203. In the following the user profile data extracted in this step is referred to as “extracted user profile records.”

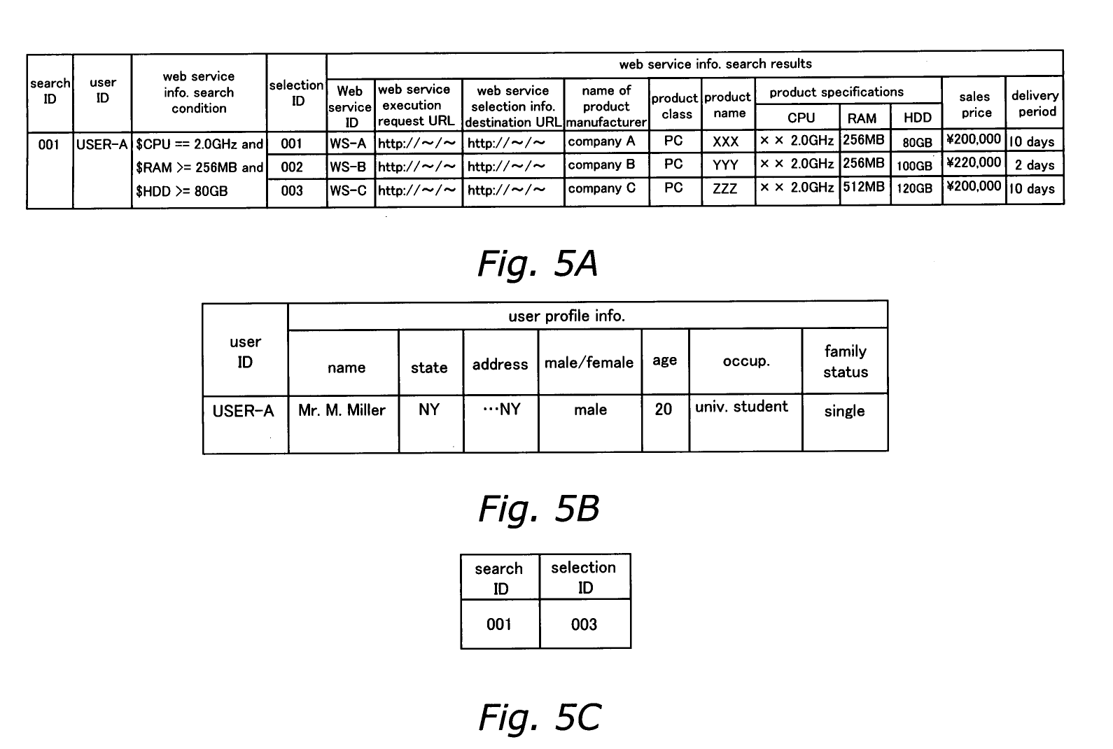

Step S54: The sending portion 103 sends the result data including the search result records, the extracted user profile records and the selection result specific information that is included in the web service selection data to the web service servers 2 specified by the web service IDs included in the search result records, that is, in this example to the web service server 2a, the web service server 2b and the web service server 2c. The result data may be a text file including the information as shown for example in FIG. 5.

With the above processing, information related to the web services searched by the user, information related to the web service selected by the user, that is, the web service specifying the web service server 2c, and the user profile are sent to the web service server 2c from which execution of web services has been requested through selection by the user. Consequently, the provider of the web service server 2c can monitor whether the web service provided by the provider of the web service server 2c has been selected, and acquire information related to the web services 2a and 2b whose execution has not been requested even though a search was performed, as well as the profile of the user who has selected the service provided by the web service server 2c. And based on this information, the provider of the web service server 2c can perform a market analysis or the like.

With the above process, information related to the web service selected by the user as well as the user profile is sent also to the web service servers 2a and 2b that have been displayed on the selection screen but that have not been selected. Consequently, the providers of the web service servers 2a and 2b can search and analyze, based on the result data, the reasons whey their web services have not been selected.

Second Embodiment

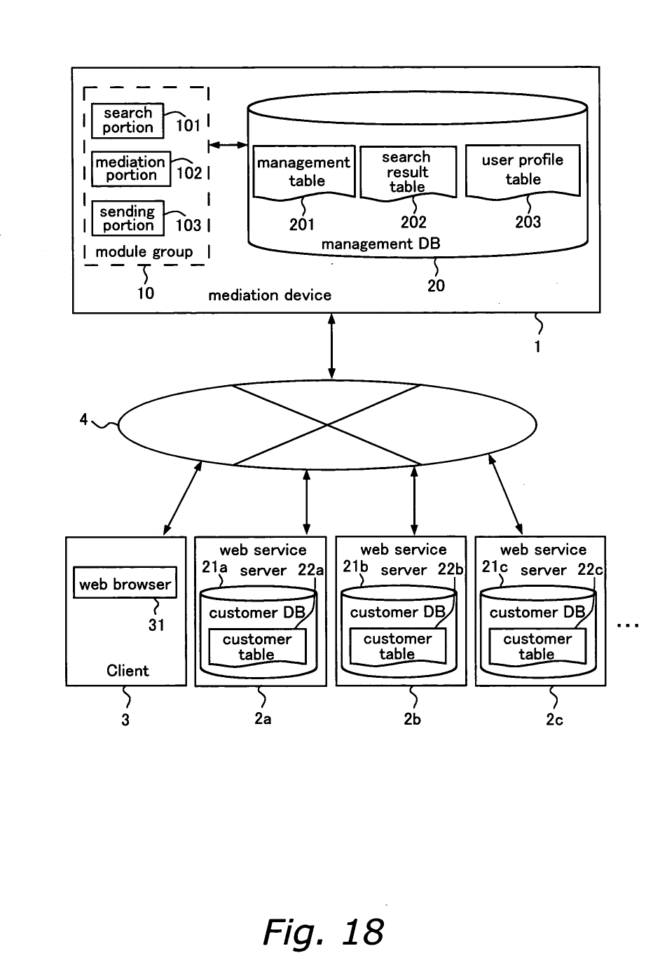

FIG. 18 is a diagram showing the overall configuration of a web service mediation system according to a second embodiment. Like the system in the first embodiment, this system includes a mediation device 1, web service servers 2 and a client 3. The mediation device 1 and the client 3 have the same configuration and functionality as in the first embodiment. The web service server 2 includes a customer database (DB) 21. The customer DB 21 contains a customer table 22. The customer table 22 stores information related to the users using this web service.

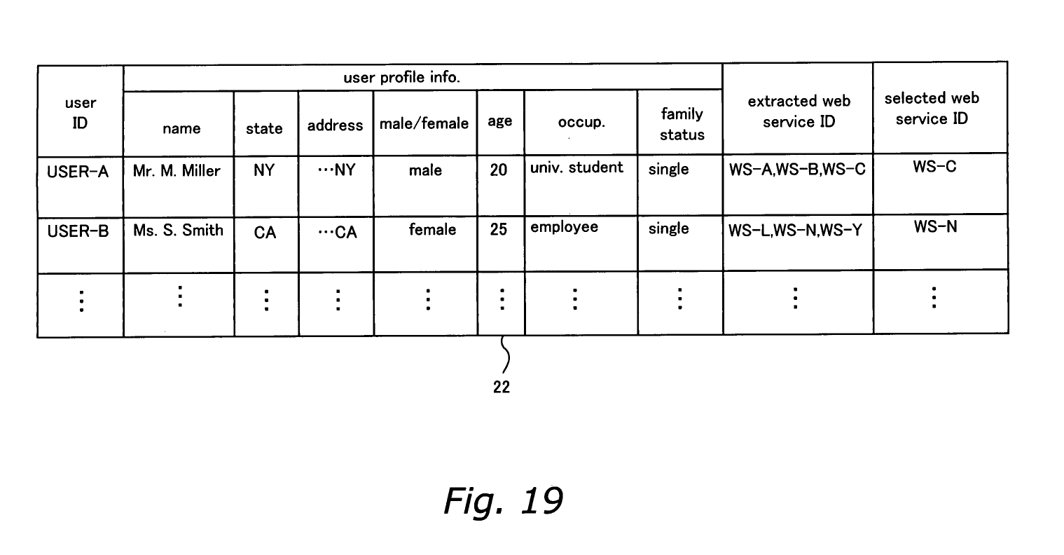

FIG. 19 is an example of the information stored in the customer table 22. The customer table 22 contains the fields “user ID,” “name,” “state,” “address,” “male/female,” “age,” “occupation,” “family status,” “extracted web service ID” and “selected web service ID.” The fields “user ID,” “name,” “state,” “address,” “male/female,” “age,” “occupation” and “family status” store the same information as the user profile table 203 of the mediation device 1 in the first embodiment. That is to say, they store the user ID and the user profile information of the first embodiment. The field “extracted web service ID” stores the ID of the web service searched by the user that is specified by the user ID stored in the field “user ID.” That is to say, the field “extracted web service ID” stores the information stored in the sub-field “web service ID” of the search result table 202 of the first embodiment. In the following, this information is referred to as “search result specific information.” The field “selected web service ID” stores the ID of the web service selected by that user. That is to say, the field “selected web service ID” stores the selection result specific information of the first embodiment.

The customer table 22 stores, correlated to one another, user IDs, user profile information, information indicating the search results of the web services, and information indicating the selection results of the web services.

In order to make this information stored in the customer table 22 (referred to as “user behavior information” in the following) available to the providers of the web service servers 2, the providers of the web service servers 2 can conclude a contract with the provider of the mediation service (referred to as “mediation service provider” in the following) through the mediation device 1, which gives them access to all or a portion of this user behavior information. For example, the provider of the web service servers 2 may pay a predetermined information access fee to the provider of the mediation service, concluding a contract that allows them to access user behavior information correlating the user IDs, user profile information, search result specific information and selection result specific information. The system may also be devised such that it is possible to access the user behavior information after optionally adding predetermined information, such as the number of times a certain web service server 2 was used, to the user behavior information or deleting user IDs from the user behavior information, in accordance with the amount of the information access fee paid.

Thus, the providers of the web service servers 2 can store the web service usage behavior of each user in the customer table 22, and can monitor and analyze the web service usage behavior of each user based on the user behavior information stored in the customer table 22.

Moreover, depending on the amount of the information access fee paid to the provider of the mediation service, the providers of the web service servers 2 can obtain information that is valuable for analyzing user behavior from the provider of the mediation service. Then, the provider of the mediation service provides user behavior information to the providers of the web service servers 2, and, in turn, can obtain from the providers of the web service servers 2 profits due to the information access fee.

On the other hand, it is also possible that the service fee arising when the user utilizes the web service servers 2 (for example the purchase price when the user buys products sold by the web service servers) is discounted by the provider of the mediation service, so that the profits due to the information access fee obtained by the provider of the mediation service are returned to the user. This way, the incentives for the user to use the mediation device 1 and, through the mediation device 1, the web service servers 2 is increased in form of discounts on the service fees, so that both the provider of the mediation service and the providers of the web service servers 2 can expect an increase in user numbers. Moreover, by increasing the number of users, the providers of the web service servers 2 can expect increased revenues of service fees. On the other hand, the provider of the mediation service can expect increased revenues of information access fees, as the usage needs of the user behavior information of the provider of the web service servers 2 increase.

Other Embodiments

(A) It is also possible to send the extracted user profile data of the first embodiment to the web service servers 2 after eliminating from them any information with which individuals can be identified. This allows the protection of privacy of users.

(B) It is also possible to devise the system such that in Step S54 of the result data sending process of the first embodiment, a permission to send result data is received from the providers of the web service server 2c. And, the result data is sent to the web service servers 2a and 2b only if the provider's permission has been received. This way, it can be prevented that useful information is sent to providers of competing web services.

(C) The scope of the present invention also encompasses a recording medium on which a program executing the method of the present invention is recorded. Examples of suitable recording media include computer-readable flexible disks, hard-disks, semiconductor memories, CD-ROMs, DVDs and MOs.

With the present invention, the usage value of web services can be increased by making it possible to monitor user behavior.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A network service mediation method for mediating execution of one or a plurality of network services that are provided over a network, the method comprising the steps of:
storing network service information related to the network services;
receiving an entry of a search condition for searching the network services;
extracting network service information for which the search condition is true;
receiving a selection of one or a plurality of network services from the network services corresponding to the extracted network service information;
requesting execution of the selected one or plurality of network services; and
sending selection information related to the selection of the network services.

2. The network service mediation method according to claim 1, wherein the network service information comprises network service specific information for which the network service can be specified.

3. The network service mediation method according to claim 2, wherein in the sending step, a portion or all of the network service information related to the selected one or plurality of network services is sent to some or all of the network service servers that execute the network services specified by the network service specific information comprised in the extracted network service information.

4. The network service mediation method according to claim 1, wherein the selection information comprises the search condition.

5. The network service mediation method according to claim 1, further comprising the step of storing user information related to users who can enter search conditions,
wherein the selection information comprises some or all of the user information of users who have specified search conditions.

6. The network service mediation method according to claim 1, further comprising the step of receiving a permission to send network service information,
wherein the sending step is executed if that permission has been received.

7. The network service mediation method according to claim 1, wherein the storing step comprises the steps of accessing, at a predetermined timing, a database storing in correlation to one another the network services and the network service information which is related to content of the network services, and obtaining and storing the network service information.

8. The network service mediation method according to claim 1, wherein the selection information comprises the network service information extracted in the extracting step.

9. A network service mediation method for mediating execution of one or a plurality of network services that are provided over a network, the method comprising the steps of:
receiving an entry of a search condition for searching the network services;
requesting, from a database in which the network services and network service information related to content of the network services are stored in correlation to one another, extraction of a network service or network services corresponding to network service information for which the search condition is true;
receiving a selection of one or a plurality of network services from the extracted network services;
requesting execution of the selected one or plurality of network services; and
sending service extraction selection information related to the extraction or selection of the network services to at least one of the extracted network services.

10. A network service mediation device for mediating execution of one or a plurality of network services that are provided over a network, the device comprising:
a storage means for storing network service information related to the network services;
a search condition entry means for receiving an entry of a search condition for searching the network services;
an extraction means for extracting network service information for which the search condition is true;
a selection means for receiving a selection of one or a plurality of network services from the network services corresponding to the extracted network service information;
a requesting means for requesting execution of the selected one or plurality of network services; and
a sending means for sending selection information related to the selection of the network services.

11. A network service mediation device for mediating execution of one or a plurality of network services that are provided over a network, the device comprising:
a search condition entry means for receiving an entry of a search condition for searching the network services;
an extraction requesting means for requesting, from a database in which the network services and network service information related to content of the network services are stored in correlation to one another, extraction of a network service or network services corresponding to network service information for which the search condition is true;
a selection means for receiving a selection of one or a plurality of network services from the extracted network services;
an execution requesting means for requesting execution of the selected one or plurality of network services; and
a sending means for sending service extraction selection information related to the extraction or selection of the network services to at least one of the extracted network services.

12. A network service mediation program for mediating execution of one or a plurality of network services that are provided over a network, the program causing a computer to function as:
a storage means for storing network service information related to the network services;
a search condition entry means for receiving an entry of a search condition for searching the network services;
an extraction means for extracting network service information for which the search condition is true;
a selection means for receiving a selection of one or a plurality of network services from the network services corresponding to the extracted network service information;
a requesting means for requesting execution of the selected one or plurality of network services; and
a sending means for sending selection information related to the selection of the network services.

13. A computer-readable recording medium storing a network service mediation program for mediating execution of one or a plurality of network services that are provided over a network, the program causing a computer to function as:
a storage means for storing network service information related to the network services;
a search condition entry means for receiving an entry of a search condition for searching the network services;
an extraction means for extracting network service information for which the search condition is true;
a selection means for receiving a selection of one or a plurality of network services from the network services corresponding to the extracted network service information;
a requesting means for requesting execution of the selected one or plurality of network services; and
a sending means for sending selection information related to the selection of the network services.
